(19) United States
(12) Patent Application Publication
(10) Pub. No.: US 2026/0224950 A1
(43) Pub. Date: Aug. 6, 2026

(54) GOLF BAG CART

(71) Applicant: Michael Jong CHOI, Fairfax, VA (US)

(72) Inventor: Michael Jong CHOI, Fairfax, VA (US)

(21) Appl. No.: 19/046,833

(22) Filed: Feb. 6, 2025

(51) Int. Cl. A63B 55/60; A61H 3/04; A63B 55/57; A61H 3/00

(52) U.S. Cl. CPC A63B 55/60; A61H 3/04; A63B 55/57; A61H 2003/002; A61H 2201/1261; A61H 2201/1633; A63B 2055/601

(57) ABSTRACT

The golf bag cart capable of placing and transporting a golf bag includes: a front frame providing a contact support surface to support a golf bag in contact; a rear frame coupled to the rear of the front frame to support the front frame; a plurality of wheels respectively provided at the lower ends of the front frame and the rear frame; and a plurality of handles provided at the upper end of the front frame, wherein the front frame includes a recessed accommodation groove recessed to support the golf bag accommodated inside. The golf bag cart can restrict the lateral movement of the golf bag by a cover surface while the golf bag is positioned in the recessed accommodation groove, thereby preventing the golf bag from being separated from the golf bag cart more effectively while the user moves the golf bag placed thereon.

### BACKGROUND OF THE INVENTION

### Field of the Invention

The present invention relates to a golf bag cart, which is designed to assist in the stable transport of a golf bag during golf play while walking for exercise purposes.

### Background Art

In general, to use a golf bag on the field, the golf bag is loaded and transported on a transport device such as a cart or is moved by a person carrying the golf bag on the shoulder or back while walking. Accordingly, a golf bag cart is designed to be relatively compact and to transport golf bags stably.

The golf bag cart includes: a base plate on which the golf bag can be placed; a frame which is connected to the base plate and forms the exterior of the golf bag cart; and wheels provided at the bottom of the frame.

A user can move the golf bag cart by holding a handle of the golf bag cart and pushing the frame forward. Conventionally, during the movement, it is common for the golf bag to shift sideways and separated from the base plate and the frame, falling to the ground.

Additionally, the conventional golf bag cart generally features a one-push bar-style handle structure, so the user moves the golf bag cart while pushing the golf bag cart with one hand. Due to the limit of imbalance during movement, the golf bag cart frequently loses balance and overturns, or the golf bag is separated from the golf bag cart.

Additionally, many conventional golf bag carts are equipped with three wheels and a one-push bar-style handle structure. In such cases, on an uneven slope, the golf bag cart often loses balance, tilts sideways, and falls or overturns. In this instance, golf clubs may be separated from the golf bag.

In addition, due to the structural problem of the conventional golf bag carts, which are designed to be pushed only with one hand, the conventional golf bag carts increase the fatigue of the user's waist and legs. Therefore, the present invention proposes a golf bag cart equipped with a two-push bar-style handle structure that allows the user to push and move the golf bag cart with both hands, enabling the golf bag cart to also function as a walker.

### SUMMARY OF THE INVENTION

Accordingly, the present invention has been made to solve the above-mentioned problems occurring in the prior arts, and it is an objective of the present invention to provide a golf bag cart that prevents the cart from easily overturning during the transportation of a golf bag, stably prevents the golf bag from being separated from the golf bag cart, and functions as a walker to reduce a user's waist and leg fatigue.

To accomplish the above object, according to the present invention, there is provided a golf bag cart capable of placing and transporting a golf bag, including: a front frame providing a contact support surface to support a golf bag in contact; a rear frame coupled to the rear side of the front frame to support the front frame; a plurality of wheels respectively provided at the lower ends of the front frame and the rear frame; and a plurality of handles provided at the upper end of the front frame, wherein the front frame includes a recessed accommodation groove recessed to support the golf bag accommodated inside.

As described above, the golf bag cart according to the present invention can restrict the lateral movement of the golf bag by a cover surface while the golf bag is positioned in the recessed accommodation groove, thereby preventing the golf bag from being separated from the golf bag cart more effectively while the user moves the golf bag placed thereon.

Additionally, the golf bag cart according to the present invention, which is a new type of golf bag cart including four wheels and two handles, can prevent the cart from easily overturning during the transportation of a golf bag, stably prevent the golf bag from being separated from the golf bag cart, and function as a walker to reduce the user's waist and leg fatigue.

In addition, the golf bag cart according to the present invention additionally includes the supporter accommodation groove, allowing the golf bag to be stably positioned within the recessed accommodation groove with sufficient restriction of lateral movement.

### BRIEF DESCRIPTION OF THE DRAWINGS

FIG. 1 is a perspective view illustrating a state in which a golf is placed on a golf bag cart according to an embodiment of the present invention.

FIG. 2 is a perspective view of the golf bag cart according to an embodiment of the present invention.

FIG. 3 is an exploded perspective view of the golf bag cart according to an embodiment of the present invention.

FIG. 4 is a plan view illustrating a state in which the golf bag is accommodated in a recessed accommodation groove of the golf bag cart according to an embodiment of the present invention.

FIG. 5 is a plan view illustrating a modified example of FIG. 4.

FIG. 6 is a perspective view illustrating a seat of the golf bag cart according to an embodiment of the present invention.

FIG. 7 is a bottom view of FIG. 6.

FIG. 8 is a diagram illustrating a state in which the supporter extends from the golf bag to support a golf bag body.

### DETAILED DESCRIPTION OF THE PREFERRED EMBODIMENT

Hereinafter, embodiments of the present invention will be described in more detail with reference to the accompanying drawings. However, the present invention is not limited to the embodiments disclosed below and may be realized in various other forms. The exemplary embodiments are provided so that the present invention is completely disclosed, and a person of ordinary skilled in the art can fully understand the scope of the present invention. In the drawings, the same reference numerals refer to the same elements.

A golf bag cart according to a preferred embodiment of the present invention includes a recessed accommodation groove, allowing the golf bag to be stably supported when accommodated inside to ensure the golf bag in a more securely mounted state. Furthermore, the golf bag cart can more stably prevent the golf bag from being separated from the golf bag cart during transportation.

Additionally, the present invention provides a two-push bar style handle structure, enabling the user to push the golf bag cart with both hands while moving, so serving a walker function.

Hereinafter, the present invention will be described in detail with reference to the embodiments.

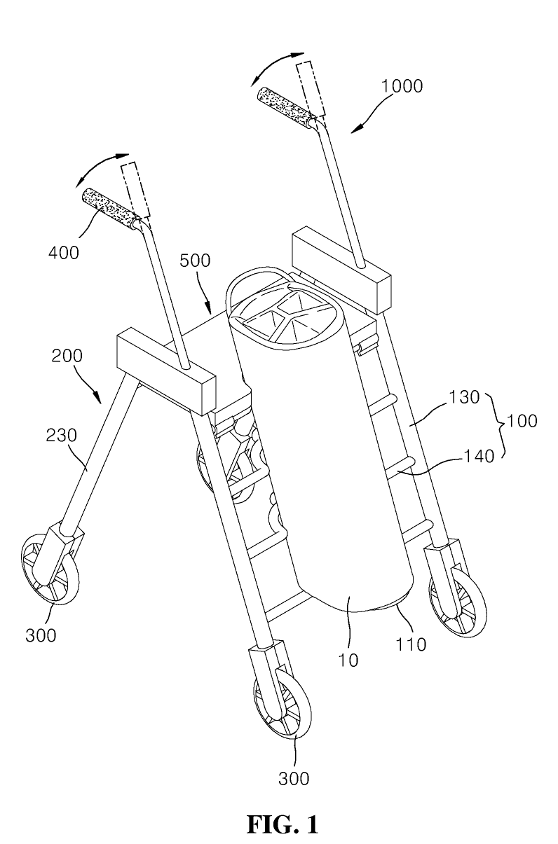

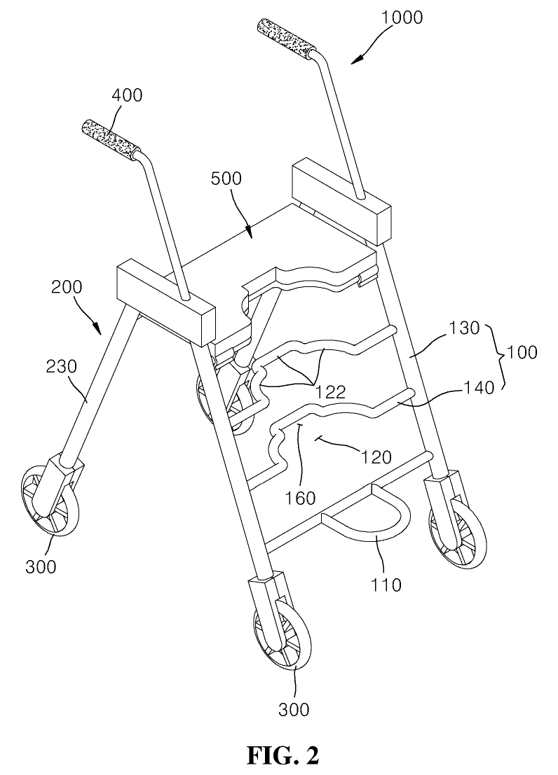

As illustrated in FIGS. 1 and 2, the golf bag cart 1000 according to an embodiment of the present invention, which transports a golf bag 10 by placing the golf bag 10 thereon, includes a front frame 100, a rear frame 200, moving wheels 300, and handles 400. A user can utilize the golf bag cart 1000 for transporting a golf bag on a golf course or as a walker to assist the user in walking with straight back and spine in a correct posture.

The front frame 100 is made of a metallic material and provides a contact support surface for the golf bag 10. The rear frame 200 is coupled to the rear of the front frame 100 and is arranged to support the front frame 100. The front frame 100 and the rear frame 200 may be made of metal or plastic materials with sufficient rigidity.

The front frame 100 is inclined relative to the ground, and includes a golf bag support 110 formed to protrude from a lower portion of the front frame 100 to support the golf bag 10 from below.

The moving wheels 300 are respectively provided at the lower ends of the front frame 100 and the rear frame 200. In the embodiment of the present invention, for example, four moving wheels may be provided. Additionally, a plurality of handles 400 are arranged at the upper end of the front frame 100, for example, two handles are provided. The user can transport the golf bag on the golf bag cart by pushing the golf bag cart while holding the two handles 400 (two push bar style handle structure) or can use the golf bag cart as a walker, as described above.

As described above, the present invention proposes a new type of golf bag cart with four moving wheels 300 and two handles 400. The golf bag cart can prevent the golf bag cart from easily overturning during the transportation of the golf bag, stably prevent the golf bag from being separated from the golf bag cart, and function as a walker to reduce the user's waist and leg fatigue.

Additionally, differently from the conventional golf bag cart, the golf bag cart according to the present invention has a new type structure including four moving wheels 300 and two handles 400, thus significantly improving balance and stability during movement. In other words, the golf bag cart can prevent situations where the golf bag cart loses balance, tilts sideways, or overturns during movement on a uneven slope.

Here, the handle 400 may include a hinge structure to variably adjust an installation angle relative to the front frame 100. Additionally, the handle 400 may be configured to allow length adjustment.

As illustrated in FIGS. 1 to 5, the front frame 100 includes a recessed accommodation groove 120 recessed to support the golf bag 10 in an accommodated state.

Specifically, the front frame 100 includes a pair of first support frames 130 and a plurality of front connection frames 140.

The pair of first support frames 130 are directly connected to the rear frame 200 and arranged apart from each other. The plurality of front connection frames 140 are arranged apart from each other in the longitudinal direction of the pair of first support frames 130 and connect the pair of first support frames 130. Here, the recessed accommodation groove 120 is formed in the plurality of front connection frames 140. The recessed accommodation groove 120 may be formed in all or some of the front connection frames 140.

In the embodiment of the present invention, as illustrated in FIG. 1, the pair of first support frames 130 are inclined relative to the ground, and an inclination angle (tilt angle) may range from 30 to 80 degrees.

In addition, the inclination angle can preferably provide a sense of stability by slightly lowering the overall height of the golf bag cart. If the inclination angle is too steep, the user’s forward view may be obstructed by the golf bag 10 when the golf bag 10 is placed, leading to inconvenience in movement and decreased operational safety.

The plurality of recessed accommodation grooves 120 formed in the plurality of front connection frames 140 are arranged parallel to each other. Therefore, when the golf bag 10 is placed, the plurality of front connection frames 140 are positioned inside the recessed accommodation grooves 120 in the longitudinal direction of the golf bag 10.

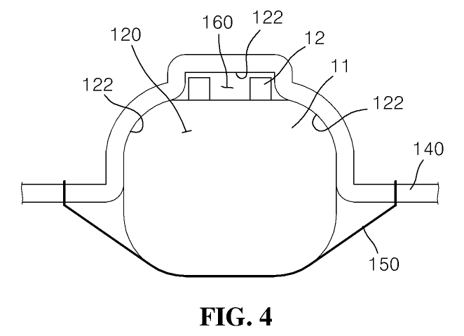

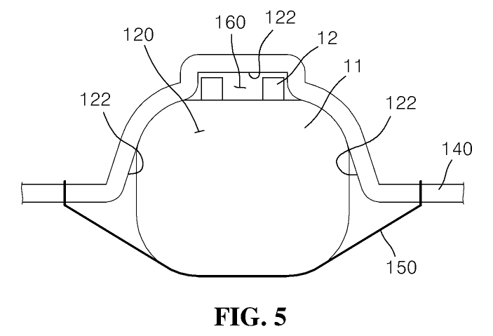

In the embodiment of the present invention, as illustrated in FIGS. 4 and 5, the recessed accommodation groove 120 includes a cover surface 122 that includes selection points and covers at least one-third of the circumferential surface of the golf bag 10, based on any selection point selected arbitrarily in the longitudinal direction of the golf bag 10. Preferably, the recessed accommodation groove 120 provides the cover surface 122 that covers at least one-half of the circumferential surface of the golf bag 10.

Here, as illustrated in FIG. 4, the cover surface 122 refers to a surface that directly contacts the outer surface of the golf bag 10 or, as illustrated in FIG. 5, is a surface that is arranged in close proximity within a certain distance from the outer surface of the golf bag 10.

The cover surface 122 is formed on a portion of the pair of first support frames 130, which form the recessed accommodation groove 120 and face the outer surface of the golf bag 10.

In other words, in the embodiment of the present invention, the golf bag 10 is restricted from lateral movement to a certain extent by the cover surface 122 when placed in the recessed accommodation groove 120, thereby further preventing the golf bag from being detached from the golf bag cart 1000 while the golf bag cart transports the golf bag by the user.

As illustrated in FIGS. 4 and 5, a strap 150 may be further provided on the plurality of front connection frames 140 to wrap around the front portion of the golf bag 10 placed in the recessed accommodation groove 120 to prevent the golf bag 10 from being separated forward. The strap 150 can be made of elastic material to further prevent the golf bag from being separated from the golf bag cart 1000. To selectively allow or restrict the forward movement of the golf bag 10, the user can freely wrap the front portion of the golf bag 10 using the strap 150.

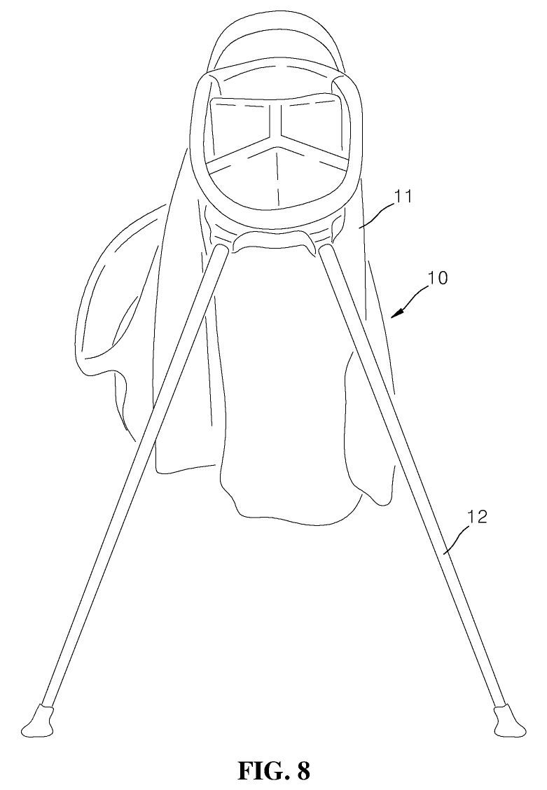

In general, as illustrated in FIGS. 4, 5, and 8, the golf bag 10 includes a golf bag body 11 and a plurality of supporters 12 which are rotatably attached to the golf bag body 11 to allow the golf bag body 11 to stand on the ground.

In the embodiment of the present invention, as illustrated in FIGS. 2 to 5, the plurality of front connection frames 140 are provided with supporter accommodation grooves 160 which are concaved inwardly as part of the recessed accommodation groove 120 to support the plurality of supporters 12 accommodated inside, excluding the golf bag body 11.

Thus, when the golf bag body 11 is placed in the recessed accommodation groove 120, and the plurality of supporters 12 are accommodated in the supporter accommodation grooves 160.

In a folded state, the plurality of supporters 12 protrude from the outer surface of the golf bag body 11. If the supporter accommodation grooves 160 were not provided, it might be difficult to maintain the stable arrangement of the golf bag 10 that the plurality of supporters 12 restrict the lateral movement of the golf bag 10 inside the recessed accommodation groove 120. However, with the provision of the supporter accommodation grooves 160, the golf bag 10 can be stably placed in the recessed accommodation groove 120 with sufficient lateral movement restriction.

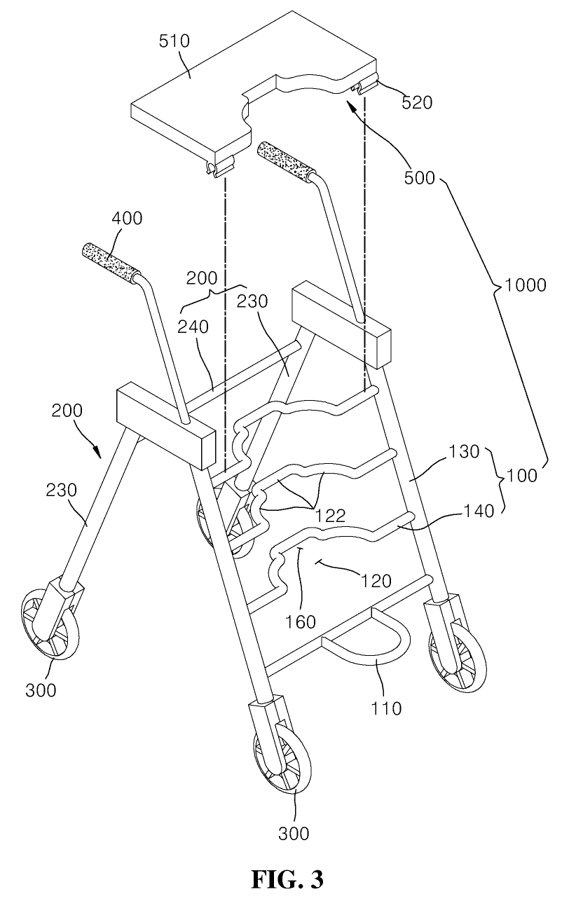

As illustrated in FIGS. 2 and 3, the rear frame 200 includes a pair of second support frames 230 and a plurality of rear connection frames 240.

The pair of second support frames 230 are coupled to the rear side of the pair of first support frames 130, and spaced apart from each other to support the pair of first support frames 130. The plurality of rear connection frames 240 are spaced apart from each other in the longitudinal direction of the pair of second support frames 230 and connect the pair of second support frames 230.

In the embodiment of the present invention, the front connection frames 140 and the rear connection frames 240 may be formed in a tubular shape, such as a circular tube.

In the embodiment of the present invention, although not specifically illustrated in the drawings, the front frame 100 and the rear frame 200 can be connected via a foldable connection structure.

Thus, after completing a golf game, the user can fold the golf bag cart to reduce the overall volume, making it easier to carry and store. The foldable connection structure may include a hinge shaft connected to the front frame 100 and the rear frame 200 via a rod or a bar. Besides the foldable connection structure, other known structures can be applied.

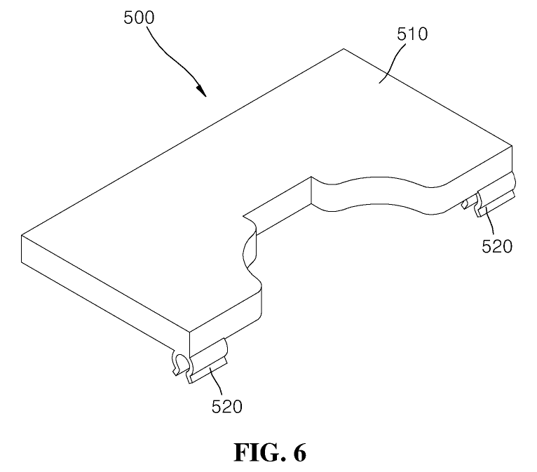

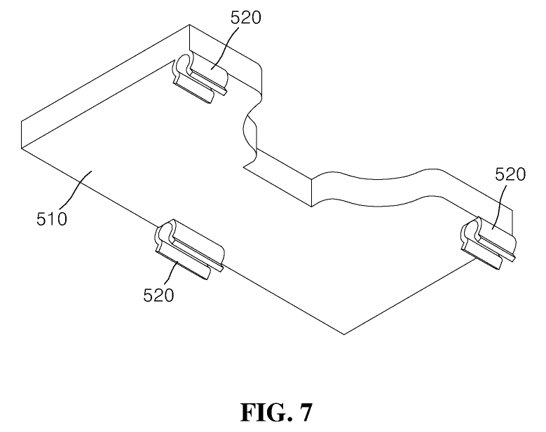

In the embodiment of the present invention, as illustrated in FIGS. 2, 3, 6, and 7,a seat 500 may be provided to connect corresponding front connection frames 140 and rear connection frames 240 with each other among the plurality of front connection frames 140 and rear connection frames 240.

Additionally, when the front connection frames 140 and the rear connection frames 240 are provided in the plural, the seat 500 may be installed to connect the uppermost front connection frame 140 and the uppermost rear connection frame 240.

As illustrated in FIGS. 2 and 3, the seat 500 may include: a seat body 510; and a plurality of clamps 520 provided at the lower portion of the seat body 510, and coupled with the front connection frame 140 and the rear connection frame 240, which are tubular, using a one-touch push mechanism.

The clamp 520 may have an approximately "C"-shaped cross-sectional structure and is preferably made of an elastic material to allow elastic deformation. After moving the seat 500 downward from above the front connection frame 140 and the rear connection frame 240, the user can easily couple the clamp 520 to the front connection frame 140 and the rear connection frame 240 by pressing downwardly the seat 500 above the front connection frame 140 and the rear connection frame 240 in a one-touch push manner. Once the seat 500 is coupled, the user can sit on the seat.

As described above, although the present invention has been described in connection with the preferred embodiment for illustrating the principle of the present invention, the present invention is not limited to the aforementioned specific embodiments. It will be appreciated to those skilled in the art that the present invention can be changed and modified in various manners without departing from the spirit and scope of the present invention.

What is claimed is:

1. A golf bag cart configured to place and transport a golf bag, comprising:
a front frame having a contact support surface to support the golf bag;
a rear frame coupled to a rear side of the front frame to support the front frame;
a plurality of wheels respectively positioned at first ends of the front frame and first ends of the rear frame; and
a plurality of handles coupled to second ends of the front frame, the second ends being opposite to the first ends of the front frame,
wherein the front frame includes a recessed accommodation groove to accommodate at least a part of the golf bag therein.

2. The golf bag cart according to claim 1, wherein the front frame comprises:
a pair of first support frames directly connected to the rear frame and spaced apart from each other; and
a plurality of front connection frames configured to connect the pair of first support frames and arranged to be spaced apart in a longitudinal direction of the pair of first support frames,
wherein the plurality of front connection frames include the recessed accommodation groove.

3. The golf bag cart according to claim 2, wherein the recessed accommodation groove is configured to provide a cover surface which covers at least one-third of a circumferential surface of the golf bag.

4. The golf bag cart according to claim 3, wherein the recessed accommodation groove is configured to provide the cover surface which covers at least one-half of the circumferential surface of the golf bag.

5. The golf bag cart according to claim 2, wherein the golf bag comprises a golf bag body including a plurality of supporters that are configured to rotate to allow the golf bag body to stand on a ground, and
wherein the plurality of front connection frames have supporter accommodation grooves which are a concaved portion of the recessed accommodation groove to support and accommodate the plurality of supporters therein.

6. The golf bag cart according to claim 2, wherein the rear frame comprises:
a pair of second support frames, each coupled to the rear side of each of the pair of first support frames to support the first support frames; and
a plurality of rear connection frames, configured to connect the pair of second support frames, spaced apart from each other and arranged in the longitudinal direction of the pair of the second support frames,
wherein the golf bag cart further includes a seat positioned to connect one of the plurality of front connection frames and one of the plurality of rear connection frames.

7. The golf bag cart according to claim 6, wherein the seat comprises:
a seat body; and
a plurality of clamps disposed at a bottom portion of the seat body and configured to be coupled to at least one of the plurality of front connection frames and the plurality of rear connection frames using a one-touch push mechanism, wherein each of the plurality of front connection frames and the plurality of rear connection frames has a tubular shape.

8. The golf bag cart according to claim 2, wherein the plurality of front connection frames include a strap to wrap around a front portion of the golf bag placed in the recessed accommodation groove to prevent the golf bag from being separated forward.
